(19) United States
(12) Patent Application Publication
(10) Pub. No.: US 2005/0234736 A1
(43) Pub. Date: Oct. 20, 2005

(54) Certification method for quality management system

(76) Inventor: Brian P. Little, St. Louis Park, MN (US)

Correspondence Address: MERCHANT & GOULD PC, P.O. BOX 2903, MINNEAPOLIS, MN, 55402-0903, US

(21) Appl. No.: 11/069,780

(22) Filed: Mar. 1, 2005

Related U.S. Application Data
(60) Provisional application No. 60/549,214, filed on Mar. 1, 2004.

(51) Int. Cl. G06F 17/30

(52) U.S. Cl. 705/1

(57) ABSTRACT

A method of evaluating the quality management characteristics of a business is disclosed. The method includes identification of criteria for evaluating the business, said criteria comprising one or more of customer focus, leadership, involvement of people, process approach, system approach to management, continual improvement, factual approach to decision making, and mutually beneficial supplier relationships; providing a quantitative grade for each of the identified criteria; evaluating the quantitative grade for each of the identified criteria; and providing an output of favorable or unfavorable evaluation results based upon evaluating the quantitative grade for each identified criteria.

### REFERENCE TO PRIORITY APPLICATION

This application claims the benefit of Provisional Application No. 60/549,214, filed Mar. 1, 2004 which is incorporated by reference herein in its entirety.

### BACKGROUND

Various quality management systems have been developed. However, it is often difficult to provide an accurate assessment of whether a quality management system has been developed that meets basic criteria. Therefore, a need exists for systems and methods for evaluating quality management systems.

### SUMMARY OF THE INVENTION

The present invention is directed, in part, to a method and system for certifying businesses to a quality management system, such as ISO 9004. The invention includes methods of certifying businesses to quality management systems guidelines for performance improvement.

### DETAILED DESCRIPTION

Certification and guidance is based on eight quality management principles. Successful use of the management principles will result in improved monetary returns, the creation of value, and other benefits to the organization, its customers and suppliers. These quality management principles are integrated in the contents of this International Standard. In certain implementations of the invention criteria are provided for the subject matter of customer focus, leadership, involvement of people, process approach, system approach to management, continual improvement, factual approach to decision making, and mutually beneficial supplier relationships.

With regard to customer focus, the present system of certification recognizes that organizations depend on their customers and therefore should understand current and future customer needs. Specifically, an organization should meet their customer requirements and strive to exceed customer expectations. The present system measures the success at which an organization meets this objective, and uses this measurement along with measurements for other criteria to make a determination of whether the organization can be certified to the quality management system.

With regard to leadership, the present system recognized that leaders establish unity of purpose and direction of the organization. They should create and maintain the internal environment in which people can become fully involved in achieving the organization's objectives. The present system measures the success at which an organization meets this objective, and uses this measurement along with measurements for other criteria to make a determination of whether the organization can be certified to the quality management system.

With regard to involvement of people, the present system recognizes that people at all levels are the essence of an organization and their full involvement enables their abilities to be used for the organization's benefits. The present system measures the success at which an organization meets this objective, and uses this measurement along with measurements for other criteria to make a determination of whether the organization can be certified to the quality management system.

With regard to process approach, the present system recognizes that a desired result is achieved more efficiently when activities and related resources are managed as process. The present system measures the success at which an organization meets this objective, and uses this measurement along with measurements for other criteria to make a determination of whether the organization can be certified to the quality management system.

With regard to system approach to management, the present invention recognizes that identifying understanding of the organization's overall performance should be a permanent objective of the organization. The present system measures the success at which an organization meets this objective, and uses this measurement along with measurements for other criteria to make a determination of whether the organization can be certified to the quality management system.

With regard to continual improvement, the present invention recognizes that continual improvement of the organization's overall performance should be a permanent objective of the organization. The present system measures the success at which an organization meets this objective, and uses this measurement along with measurements for other criteria to make a determination of whether the organization can be certified to the quality management system.

With regard to factual approach to decision making, the present invention recognizes that effective decisions are based on the analysis of data and information. The present system measures the success at which an organization meets this objective, and uses this measurement along with measurements for other criteria to make a determination of whether the organization can be certified to the quality management system.

With regard to mutually beneficial supplier relationships, the invention takes into account that an organization and its suppliers are interdependent and a mutually beneficial relationship enhances the ability of both to create value. The present system measures the success at which an organization meets this objective, and uses this measurement along with measurements for other criteria to make a determination of whether the organization can be certified to the quality management system.

These principles include the following, which are subsequently measured as described below:
a) Customer focus
   Organizations depend on their customers and therefore should understand current and future customer needs, should meet customer requirements and strive to exceed customer expectations.
b) Leadership
   Leaders establish unity of purpose and direction of the organization. They should create and maintain the internal environment in which people can become fully involved in achieving the organization's objectives.
c) Involvement of people
   People at all levels are the essence of an organization and their full involvement enables their abilities to be used for the organization's benefits.
d) Process approach
   A desired result is achieved more efficiently when activities and related resources are managed as process.
e) System approach to management
   Identifying, understanding of the organization's overall performance should be a permanent objective of the organization.
f) Continual improvement
   Continual improvement of the organization's overall performance should be a permanent objective of the organization.
g) Factual approach to decision making
   Effective decisions are based on the analysis of data and information.
h) Mutually beneficial supplier relationships
   An organization and its suppliers are interdependent and a mutually beneficial relationship enhances the ability of both to create value.

ISO 9004 certification evaluates and defines the maturity of the Quality Management System for each major clause of ISO 9004 on a scale ranging from 1 (little effect; reactive approach) to 5 (best performance demonstrated). Results of a professional audit using the following detailed assessment will quantify the performance level of a company's Quality Management System's effectiveness and strength.

The three levels of ISO 9004 certification are ISO 9004 C: Continual Improvement Demonstrated, ISO 9004 B: Continual Improvement Emphasized and Sustained, ISO 9004 A: Best Performance Demonstrated

| Overall | | |
|---|---|---|
| Performance Level | | |
| (Performance Points) | Performance | Reference |
| 1 | Little effect; | Problem or corrective - based |
| (27-53) | Reactive | systematic approach; Minimum |
| | approach | data on improvement results |
| | | available or poor results |
| 2 | Stable formal | Systematic process-based |
| (54-80) | system | approach; early stage of |
| | approach | systematic improvements; data |
| | | available on conformance to |
| | | objectives and existence of |
| | | improvement trends. |
| 3 | Continual | Improvement process in use; |
| ISO 9004 C | improvement | results identified; improvement |
| (81-99) | demonstrated | trends documented. |
| 4 | Continual | Improvement process is cultural; |
| ISO 9004 B | improvement | results substantial; improvement |
| (100-117) | emphasized | rends sustained and maturing. |
| | and sustained. | |
| 5 | Best | Strongly integrated improvement |
| ISO 9004 A | performance | process; best performance |
| (118-135) | demonstrated. | benchmarked results |
| | | demonstrated. |

ISO 9004 Certification Performance Levels
Level C = 81-99 Points
Level B = 100-117 Points
Level A = 118-135 Points

Managing Systems and Processes. The following example provides a systematic and visible way to lead and operate an organization that continually improves performance.

| | Item | Grade | Notes |
|---|---|---|---|
| 1. | Top management defines systems and | 1 2 3 4 5 | |
| | processes that can be clearly understood, | | |
| | managed and improved in effectiveness | | |
| | and efficiency. | | |
| 2. | The organization defines and promotes | 1 2 3 4 5 | |
| | processes that lead to improved | | |
| | performance. | | |
| 3. | Top management ensures effective and | 1 2 3 4 5 | |
| | efficient operation and control of | | |
| | processes and the measures and data used | | |
| | to determine satisfactory performance of | | |
| | the organization. | | |
| 4. | The organization acquires and uses | 1 2 3 4 5 | |
| | process data and information on a | | |
| | continuing basis. | | |
| 5. | The organization directs progress toward | 1 2 3 4 5 | |
| | continual improvement. | | |
| 6. | The organization uses suitable methods | 1 2 3 4 5 | |
| | to evaluate process improvement, such as | | |
| | self-assessments and management | | |
| | review. | | |

| | |
|---|---|
| AREA 4.1 OVERALL GRADE | 1 2 3 4 5 |

1. A method of evaluating the quality management characteristics of a business, the method comprising:
identification of criteria for evaluating the business, said criteria comprising one or more of customer focus, leadership, involvement of people, process approach, system approach to management, continual improvement, factual approach to decision making, and mutually beneficial supplier relationships;
providing a quantitative grade for each of the identified criteria;
evaluating the quantitative grade for each of the identified criteria;
providing an output of favorable or unfavorable evaluation results based upon evaluating the quantitative grade for each identified criteria.
